(19) United States
(12) Patent Application Publication
(10) Pub. No.: US 2024/0276183 A1
(43) Pub. Date: Aug. 15, 2024

(54) METHODS FOR HANDLING A SERVICE FOR A COMMUNICATIONS DEVICE AND NETWORK NODES IMPLEMENTING THE METHOD IN A COMMUNICATIONS NETWORK

(71) Applicant: Telefonaktiebolaget LM Ericsson (publ), Stockholm (SE)

(72) Inventors: Chunmiao Liu, Shanghai (CN); Afshin Abtin, Sollentuna (SE); lrene Martin Cabello, Madrid (ES); Liangliang Guo, Shanghai (CN); Sorin Surdila, Laval (CA)

(21) Appl. No.: 18/567,109

(22) PCT Filed: Jun. 25, 2021
(86) PCT No.: PCT/CN2021/102334

§ 371 Date: Dec. 5, 2023

(51) Int. Cl. H04W 4/12; H04W 28/02; H04W 28/26; H04W 64/00

(52) U.S. Cl. CPC H04W 4/12; H04W 28/0268; H04W 28/26; H04W 64/00

(57) ABSTRACT

A method, performed by a policy controlling node, for handling a service for a communications device. The method comprises receiving, during the establishment of the service, from an application node, a first message comprising a preliminary service information for the service and an indicator of a request to provide network-provided location information; and in response to receiving the first message, providing a second message, to a session management node controlling a data session of the communications device. The data session is associated with the service. The second message comprises an indicator of a request for early network-provided location information to be provided before resource reservation for the service is performed and an indication of a set of policies for controlling resource reservation for the service. The indication of the set of policies is based on the preliminary service information received in the first message.

### TECHNICAL FIELD

The embodiments herein relate to methods for handling a service for a communications device and network nodes implementing the method in a communications network. A corresponding computer program and a computer program carrier are also disclosed.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio access node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to evolve the specifications of the Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

### Wireless Communication Systems in 3GPP

FIG. 1 illustrates a simplified wireless communication system. Consider the simplified wireless communication system in FIG. 1, with a UE 12, which communicates with one or multiple access nodes 103-104, which in turn are connected to a network node 106. The access nodes 103-104 are part of a radio access network 10.

For wireless communication systems pursuant to 3GPP Evolved Packet System, (EPS), also referred to as Long Term Evolution, LTE, or 4G, standard specifications, such as specified in 3GPP TS 36.300 and related specifications, the access nodes 103-104 corresponds typically to Evolved NodeBs (eNBs) and the network node 106 corresponds typically to either a Mobility Management Entity (MME) and/or a Serving Gateway (SGW). The eNB is part of the radio access network 10, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

FIG. 2 illustrates a 5G reference architecture as defined by 3GPP.

For wireless communications systems pursuant to the 3GPP 5G System, 5GS (also referred to as New Radio, NR, or 5G) standard specifications, such as specified in 3GPP TS 38.300 and related specifications, on the other hand, the access nodes 103-104 of FIG. 1 correspond typically to a 5G NodeB (gNB) of a 5G Access Network (AN) 203 and the network node 106 corresponds typically to either an Access and Mobility Management Function (AMF) 206a and/or a User Plane Function (UPF) 206b. The 5G AN 203 may be a Radio Access Network (RAN) corresponding to the radio access network 10 of FIG. 1. In the 5G case the RAN is called NG-RAN (Next Generation Radio Access Network). The AMF 206a and UPF 206b are both part of the 5G Core Network (5GC). The gNBs may be inter-connected via an Xn interface, and connected to 5GC via the NG interface, more specifically via NG-C to the AMF and NG-U to the UPF. In FIG. 2 the NG-U interface is referred to as N3, while the NG-C interface is referred to as N2 in line with 3gpp terminology. An interface N1 is arranged between the UE 12 and the AMF 206a.

To support fast mobility between NR and LTE and avoid change of core network, LTE eNBs can also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

FIG. 2 further comprises an Application Function (AF) 220 that interacts with the 3GPP Core Network in order to provide services, for example to support interactions between the 5GC and an Internet Protocol (IP) Multimedia Subsystem or IP Multimedia Core Network Subsystem (IMS). Thus, the AF 220 may support IP-based multimedia services for the UE 12.

The IMS is a standardized architectural framework for delivering IP-based multimedia services. Historically, mobile phones have provided voice call services over a circuit-switched-style network, rather than strictly over an IP packet-switched network. However, now alternative methods of delivering voice, e.g., Voice over IP (VoIP), or other multimedia services have become available.

A Proxy Call Session Control Function (P-CSCF) in the role of the AF 220 may interact with the Policy and Charging Architecture of the 5GC, for example with a Policy and Charging Function (PCF) 206d. The P-CSCF may be a first contact point within the IP Multimedia Core Network (IM CN) subsystem and it may ensure that relevant Session Initiation Protocol (SIP) messages contain the correct or up to date information about a user location information of the UE 12 provided by the access network 203 currently used by the UE 12.

The 5G System architecture supports an N5 interface between the PCF 206d and the P-CSCF and also supports an Rx interface between the PCF 206d and the P-CSCF, to enable IMS service. Rx support between the PCF 206d and the P-CSCF may be needed for backwards compatibility for early deployments using Diameter between the IMS and the 5GC functions.

The PCF 206d supports a unified policy framework to govern the network behavior. Specifically, the PCF 206d may provide Policy and Charging Control (PCC) rules to a Session Management Function (SMF) 206c together with an authorized Quality of Service (QoS) to be enforced by the SMF 206c. Further, the PCF 206d may request access network information, including user location information, from the SMF 206c and reports the received access network information, including the user location information, to the P-CSCF.

The SMF 206c supports different functionalities. Specifically, the SMF 206c may receive PCC rules from the PCF 206d over an N7 interface, enforce the authorized QoS and report the access network information to the PCF 206d as mentioned above. Further, the SMF 206c may have an N4 interface to the UPF 206b.

Network Provided Location Information (NPLI) is a mechanism defined in 4G and has evolved in 5G. The function implies that based on network procedures, IMS retrieves the location, e.g., cell-id, of the UE 12. This is considered a trusted model compared to using location information provided by the UE 12. Such location information is used in multiple functions in IMS, but it is also mandated by regulation in many countries. The procedures are defined in for example 3GPP TS 23.228 v. 16.6.0 and 29.214 v. 16.40.0.

An NPLI request may be performed by the IMS, e.g., by the P-CSCF, using Rx/N5 reference points to the PCF 206d which further retrieves the user location information from the SMF 206c in 5G or a Packet Data Network (PDN) Gateway control plane Function (PGW-C) in 4G.

The SMF 206c and the PGW-C may consider whether the information is already available and accurate enough, or if the user location should be requested from the AMF 206a. The AMF 206a may in turn request the user location information from the gNB, for example depending on the UE connection management state: idle or connected.

The SMF 206c may not have the latest user location in the following scenarios:
The UE 12 moving to another cell within same gNB in connected mode will not be known to the SMF 206c.
When the UE 12 is in RRC inactive, the UE 12 will perform Connection resume per 3gpp TS 23.502 § 4.8.2.2 v. 17.0.0 and the AMF 206a will receive the latest location while the location will not be propagated to SMF in this procedure.
The UE 12 will not perform 5GC Registration procedure when changing Tracking Area (TA) within a Registration Area and thereby the CN will not receive the new location.

Such procedures of requesting NPLI normally is performed by the IMS (e.g. by the P-CSCF) in relation to QoS resource reservation for voice (e.g., Voice over NR) but as well as in call termination phase without delaying the SIP signaling.

FIG. 3 illustrates an overview of existing NPLI solution in 3GPP.

Some operators require the UE 12 to subscribe to NPLI after the P-CSCF receives a SIP INVITE message 0 including a Session Description Protocol (SDP) offer sent from the UE 12. A SIP INVITE message 1a, including the SDP offer and the NPLI, from the P-CSCF to an IMS Core 220b is delayed until NPLI response is received from the SMF 206c via the PCF 206d. FIG. 3 further illustrates how the IMS Core sends a SIP 18x message, including an SDP Answer and NPLI, to the P-CSCF. Thereafter, QoS resource reservation is performed for 5QI=1, that is for dedicated QoS flow associated with voice.

The operators may require the UE 12 to subscribe to NPLI due to for example regulations and/or a need for number translation considering numbering plans. For example, the location of the UE 12 may be used to translate short numbers such as service numbers to real routable numbers. For example, 1177 in Stockholm to Stockholm healthcare, while 1177 in another region is routed to that regions healthcare.

NPLI is triggered by the PCF 206d in response to a reception of an indication that PRELIMINARY session information was included in a Rx/N5 Request from the P-CSCF.

After receiving such a request comprising indications of Preliminary Service Info and User Location, the PCF 206d changes a 5G QoS Indicator (5QI) in the Voice Service PCC rule to 5QI=5 (indicating that default QoS flow is to be used) based on policy and instructed by the Preliminary Service Info (e.g. as disclosed in 3gpp TS 29.214). The 5QI indicates which QoS flow that is to be used, and different 5QIs are used for different services. 5QI=1 is used for voice, while a default 5QI=5 is used for signalling, such as IMS signalling. Thus, after receiving Preliminary Service Info and User Location the PCF 206d may assign the 5QI and Address Resolution Protocol (ARP) of the default QoS flow to avoid signalling to the UE 12.

### SUMMARY

However, a problem is that a change of the 5QI-value from 1 to 5 causes PCC rule installation on default QoS flow (5QI=5), which enables early media or voice payload coming to the default QoS flow. The voice payload on the default QoS flow is not allowed by some operators. Further, this also complicates SMF implementation since PCC rule installation on the default QoS flow triggers additional charging handling.

FIG. 4 illustrates a detailed signalling diagram for an existing 5G solution for retrieving NPLI by the PCF 206d after being triggered by the request comprising indications of Preliminary Service Info and User Location.

In action 401a the PCF 206d sends an Npcf_SMPolicyControl_updateNotify Request message comprising PCC rules with 5QI=5 to the SMF 206c. In action 401b the SMF 206c responds to the PCF 206d with an Npcf_SMPolicyControl_updateNotify Response message.

In action 402 the SMF 206c sends an N4 Session Modification Request message to the UPF 206b indicating to create a Packet Detection Rule (PDR) and create URR(s).

In action 403 the SMF 206c sends an Namf_EventExposure_Subscribe message to the AMF 206a comprising Location report and CellId parameters, thus comprising a request for Location report and CellId.

In action 404 the AMF 206a may request the user location from the AN 203, e.g., from a gNB, with a location Reporting Control message.

In action 405 the AN 203 optionally reports the user location to the AMF 206a with a Location report message if it was requested to do so in action 404.

In action 406 the AMF 206a sends the user location to the SMF 206c in Namf_EventExposure_Notify. The user location may be indicated by TAI and/or Cell ID.

In action 407a the SMF 206c reports the user location to the PCF 206d in Npcf_SMPolicyControl_Update(UserLocation Report).

In action 407b the SMF then receives Npcf_SMPolicyControl_Update Response from the PCF 206d.

Actions 408 to 410 are related to changing PCC rule.

In action 408 the PCF 206d sends a Npcf_SMPolicyControl_UpdateNotifyRequest including PCC rules with 5QI=1 to the SMF 206c.

In action 409 the SMF 206c sends an N4 Session Modification Request including Query Usage Report Rule (URR) to the UPF 206b.

In action 410 a charging data report is sent to a Charging Function (CHF) 225 from the SMF 206c since the change of the 5QI also changes charging.

The charging handling comprises Usage Report Rule (URR) handling on interface N4 (SMF-UPF interface) as described in actions 402 and 409 and charging report to CHF as described in action 410 of FIG. 4.

Payload is provided on default QoS Flow from action 402 to action 410. After action 410 dedicated QoS Flow is setup with 5QI=1.

An object of embodiments herein may be to obviate some of the problems related to handling NPLI and services, or at least reduce the impact of them.

According to a first aspect, the object is achieved by a method for handling a service for a communications device in a communications network. The method is performed by a policy controlling node of the communications network.

The method comprises:
receiving, during the establishment of the service, from an application node of an application layer system providing the service, a first message comprising a preliminary service information for the service and an indicator of a request to provide network-provided location information; and
in response to receiving the first message, providing a second message, to a session management node of the communications network controlling a data session of the communications device. The data session is associated with the service. The second message comprises an indicator of a request for early network-provided location information to be provided before resource reservation for the service is performed and an indication of a set of policies for controlling resource reservation for the service. The indication of the set of policies is based on the preliminary service information received in the first message.

According to a second aspect, the object is achieved by a policy controlling node. The policy controlling node is configured to perform the method according to the first aspect.

According to a third aspect, the object is achieved by a method for handling a service for a communications device in a communications network. The service is provided by an application layer system. The method is performed by a session management node.

The method comprises receiving, from a policy controlling node of the communications network and during the establishment of the service, a message comprising an indicator of a request for early network-provided location information to be provided before resource reservation for the service is performed and an indication of a set of policies for controlling resource reservation for the service.

The method further comprises reporting the early network-provided location information to the policy controlling node in response to receiving the indicator of the request for the early network-provided location information and before initiating resource reservation for the service.

The method further comprises initiating resource reservation for the service based on the received indication of the set of policies for controlling resource reservation for the service.

According to a fourth aspect, the object is achieved by a session management node. The session management node is configured to perform the method according to the third aspect.

According to a fifth aspect, the object is achieved by a method, performed by an application node of an application layer system, for handling a service for a communications device. The service is provided by the application layer system.
the method comprises providing, to a policy controlling node of the communications network, during the establishment of the service, a message comprising preliminary service information for the service and an indicator of a request for network-provided location information.

The method further comprises receiving, from the policy controlling node in response to providing the message to the policy controlling node, an early network-provided location information sent to the policy controlling node before resource reservation for the service is performed.

According to a sixth aspect, the object is achieved by an application node. The application node is configured to perform the method according to the fifth aspect.

According to a further aspect, the object is achieved by a computer program comprising instructions, which when executed by a processor, causes the processor to perform actions according to any of the aspects above.

According to a yet further aspect, the object is achieved by a carrier comprising the computer program of the aspect above, wherein the carrier is one of an electronic signal, an optical signal, an electromagnetic signal, a magnetic signal, an electric signal, a radio signal, a microwave signal, or a computer-readable storage medium.

Since the indicator of the request for the early network-provided location indication is provided to the session management node by the policy controlling node in response to receiving the preliminary service information for the service and the indicator of the request to provide the network-provided location indication it is possible to avoid installation of policies for controlling resource reservation for the service on a default QoS flow (5QI=5) when a SIP precondition is used and avoid voice payload on the default QoS flow when the SIP precondition is not used.

A further advantage of embodiments herein is that the implementation of the SMF is simplified and that the performance of the SMF and the UPF is improved since there is no need for interaction on the N4 interface for user location retrieval. The performance of the SMF is further improved since there is no need for the charging data report to the CHF.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 illustrates a simplified wireless communication system,

FIG. 2 illustrates a 5G reference architecture as defined by 3GPP,

FIG. 3 illustrates a procedure for handling NPLI in 3gpp,

FIG. 4 illustrates details of a procedure for handling NPLI in 3gpp,

FIG. 5 illustrates a communications network according to embodiments herein,

FIG. 6 illustrates a method for handling NPLI according to embodiments herein,

FIG. 7 illustrates details of a method for handling NPLI according to embodiments herein,

FIG. 8 is a flow chart and illustrates a method for handling NPLI according to embodiments herein,

FIG. 9 is a flow chart and illustrates a method for handling NPLI according to embodiments herein,

FIG. 10 is a flow chart and illustrates a method for handling NPLI according to embodiments herein,

FIG. 11 illustrates a policy controlling node for handling NPLI according to embodiments herein,

FIG. 12 illustrates a session management node for handling NPLI according to embodiments herein,

FIG. 13 illustrates an application node for handling NPLI according to embodiments herein.

FIG. 16 schematically illustrates a telecommunication network connected via an intermediate network to a host computer.

FIG. 17 is a generalized block diagram of a host computer communicating via a base station with a user equipment over a partially wireless connection.

FIGS. 18 to 21 are flowcharts illustrating methods implemented in a communication system including a host computer, a base station and a user equipment.

### DETAILED DESCRIPTION

As mentioned above, an object of embodiments herein may be to obviate some of the problems related to handling NPLI in connection with a service provided by a communications network. The service may for example be a voice service.

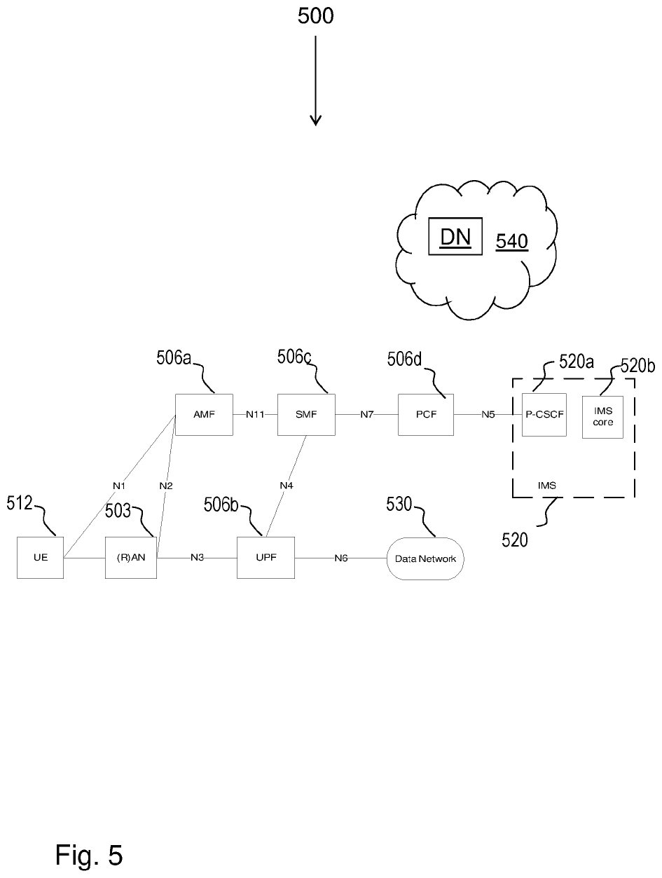

Embodiments herein relate to communications networks in general. FIG. 5 is a schematic overview depicting a communications network 500 wherein embodiments herein may be implemented. The communications network 500 comprises one or more access networks, such as an AN 503 and one or more CNs. A 5G network architecture has been used in FIG. 5 to illustrate the communications network 500. In the following description embodiments will be described with reference to this 5G reference architecture. However, embodiments are also applicable to other network architectures, in particular to 4G network architectures.

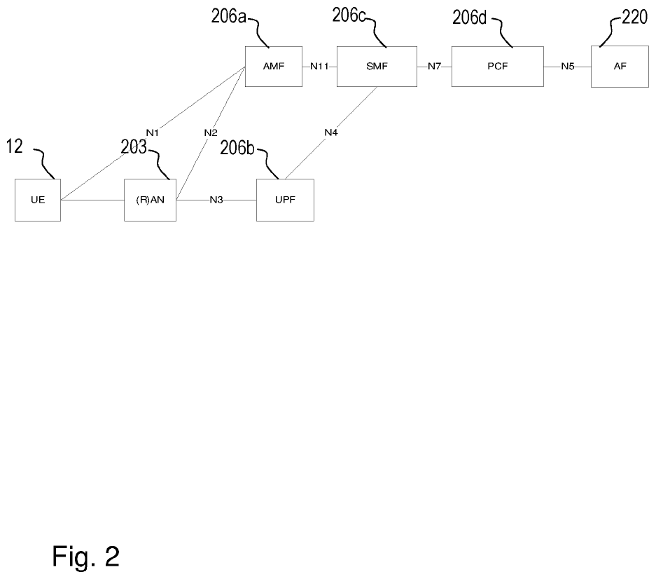

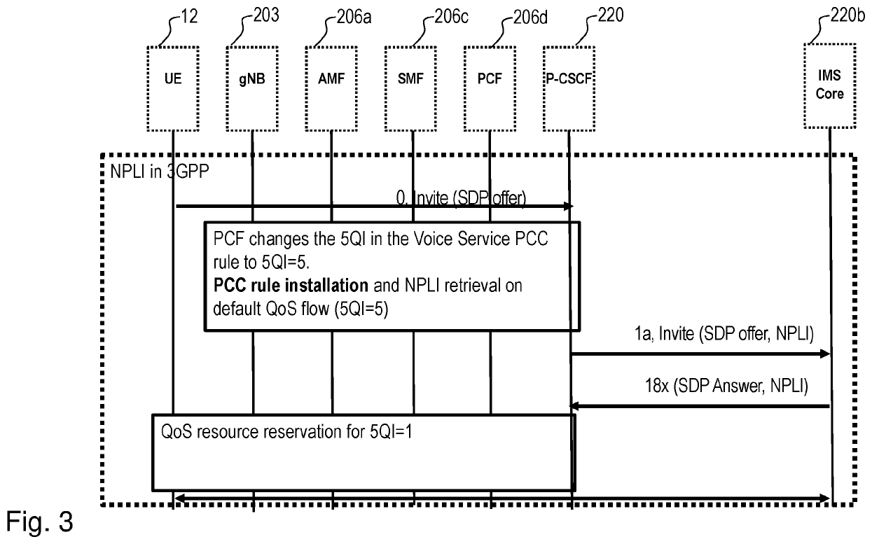

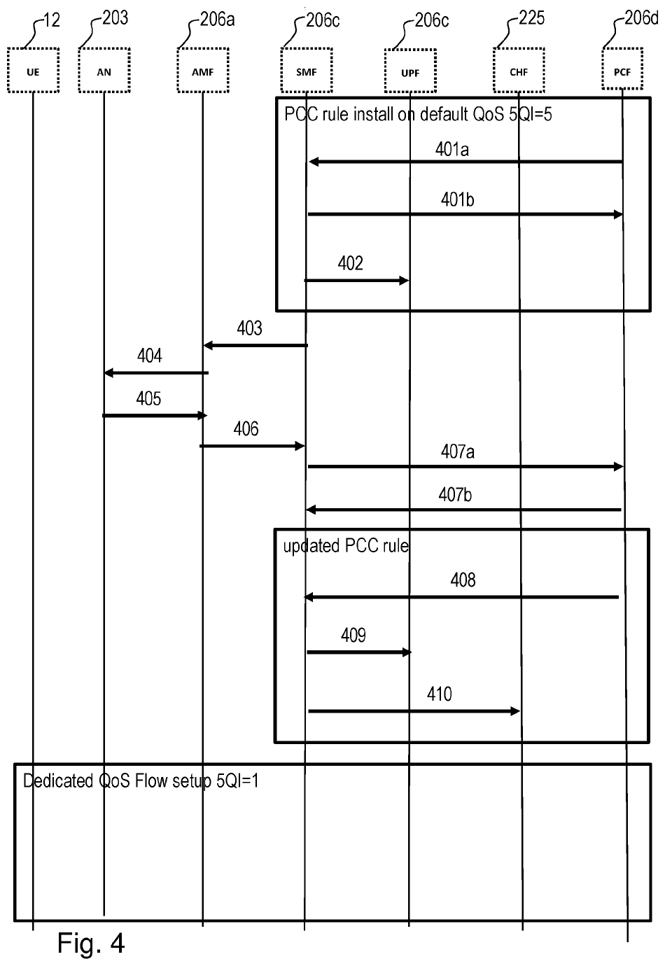

Each CN comprises one or more CN nodes, such as a session management node 506c implementing the SMF 206c and a policy controlling node 506d implementing the PCF 206d. The policy controlling node 506d may besides handling policies for resource reservation also handle charging. The CN may further comprise an access and mobility management node 506a implementing the AMF 206a and a user plane node 506b implementing the UPF 206b. The SMF 206c, the PCF 206d, the AMF 206a and the UPF 206b were all described above in relation to FIG. 2.

In a 4G-embodiment the session management node 506c and the access and mobility management node 506a may be implemented by a Mobility Management Entity (MME). The user plane node 506b may be implemented by a Packet Data Network Gateway (PDN-GW) in 4G.

The CN nodes may be logical nodes for performing the above-mentioned CN functions which each may be implemented in one or more physical nodes or devices.

The communications network 500 may be a wireless communications network. Then the AN 503 may comprise one or more RANs. The wireless communications network may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context. However, embodiments are also applicable in further development of the existing wireless communications systems such as e.g. LTE.

Access nodes operate in the communications network 500 such as a radio access node. The radio access node provides radio coverage over a geographical area, a service area referred to as a cell, which may also be referred to as a beam or a beam group of a first radio access technology (RAT), such as 5G, LTE, Wi-Fi or similar. The radio access node may be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area depending e.g. on the radio access technology and terminology used. The respective radio access node may be referred to as a serving radio access node and communicates with a UE with Downlink (DL) transmissions to the UE and Uplink (UL) transmissions from the UE.

A number of communications devices operate in the communications network 500, such as a communications device 512. The communications device 512 may be a wireless communications device. Further, the communications device 512 may be a mobile station, a non-access point (non-AP) STA, a STA, a user equipment (UE) and/or a wireless terminal, that communicate via one or more Access Networks (AN), e.g. RAN, e.g. via the radio access node to one or more CNs.

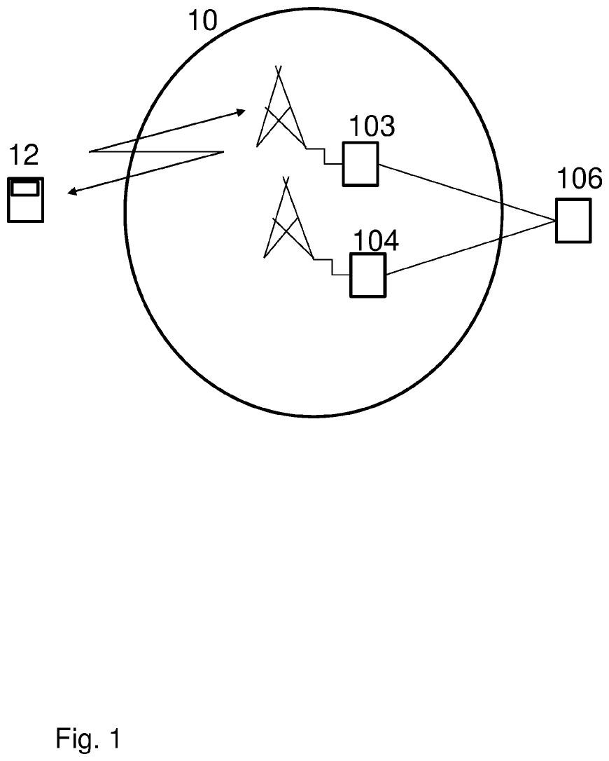

The 5G AN 503 may be a Radio Access Network (RAN) corresponding to the radio access network 10 of FIG. 1. In the 5G case the RAN is called NG-RAN (Next Generation Radio Access Network). The gNBs may be inter-connected via an Xn interface, and connected to 5GC via the NG interface, more specifically via NG-C to the AMF and NG-U to the UPF. The interfaces between the nodes of FIG. 5 correspond to the interfaces of FIG. 2. Specifically, FIG. 5 shows a first interface N1 between the communications device 512 and the access and mobility management node 506a, a second interface N2 between the AN 503 and the access and mobility management node 506a, a third interface N3 between the AN 503 and the user plane node 506b, a fourth interface N4 between the user plane node 506b and the session management node 506c, a fifth interface N5 between the policy controlling node 506d and the application node 520a and a further interface N7 between the session management node 506c and the policy controlling node 506d. The access and mobility management node 506a may further be interfaced to the session management node 506c with an interface referred to as N11.

FIG. 5 further illustrates an application layer system 520, such as an IMS, connected to the CN. The application layer system 520 comprises one or more application functions, such as the P-CSCF and IMS core functions, such as Serving-Call Session Control Function (S-CSCF), Interrogating-Call Session Control Function I-CSCF, and IMS Application Servers. The application layer system 520 comprises one or more application nodes, such as a first application node 520a and a second application node 520b for providing a service for the communications device 512. For example, the P-CSCF may be implemented by the first application node 520a while an IMS core function may be implemented by the second application node 520b. In general, the one or more application nodes may be logical nodes for performing the above-mentioned application functions. Each application node may be implemented in one or more physical nodes or devices.

Generally, an application function interacts with the CN to provide specific services, such as voice, video, and gaming, and may affect routing and/or policy decisions affecting quality of service. An example of an application function is IMS providing voice and video calling services.

The service may be provided to the communications device 512 through the CN of the communications network 500. For example, the service may be provided by a data session, such as a Protocol Data Unit (PDU) session. The data session provides end-to-end user plane connectivity between the communications device 512 and a specific Data Network 530 through the user plane node 506b. For example, for voice over IMS a PDU session for IMS voice may be provide end-to-end user plane connectivity between the communications device 512 and a second communications device in a second data network, such as a second communications network.

A data session, such as a PDU Session, may support one or more QoS Flows. There may be a one-to-one mapping between QoS Flow and QoS profile. For example, for 5G the one-to-one mapping between QoS Flow and QoS profile means that all packets belonging to a specific QoS Flow may have the same 5QI.

The session management node 506c may control the data session through the N4 interface.

It should be understood by the skilled in the art that “communications device” and “UE” are non-limiting terms which mean any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

Methods herein may in a first aspect be performed by the policy controlling node 506d and in a second aspect by the session management node 506c, and in a third aspect by the first application node 520a, which hereafter will be referred to as the application node 520a. As an alternative, a Distributed Node (DN) and functionality, e.g. comprised in a cloud 540 as shown in FIG. 5, may be used for performing or partly performing the methods.

In the cloud implementation, the functions of anyone or all of the policy controlling node 506d, the session management node 506c, and the application node 520a may be deployed in a virtualized environment. The signaling sequences between the nodes or functions does not change if some or all of them are deployed in the cloud.

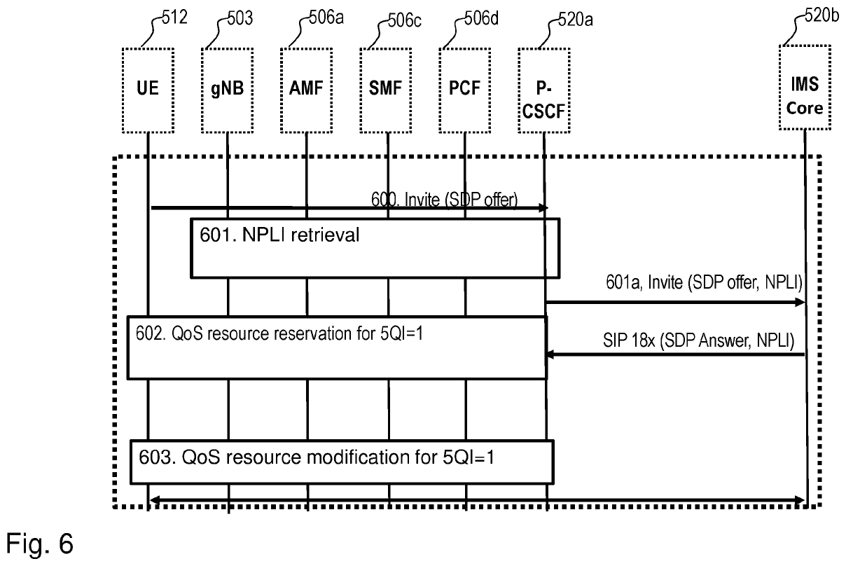

Exemplifying methods for handling a service according to embodiments herein will now be described with reference to a combined signalling diagram and flow chart of FIG. 6 describing interaction between the policy controlling node 506d, the session management node 506c, and the application node 520a. The exemplifying methods will also be described with further reference to FIG. 5. The embodiments of FIG. 6 will be described based on a 5G architecture combined with an IMS. The service provided by the application layer system 520 will be exemplified with a voice service, such as VoIP and in particular Voice over NR (VoNR).

After receiving a Preliminary Service Info message (e.g. in an Rx or N5 procedure) and a User Location request, e.g., from the IMS Core, such as from the second application node 520b, the policy controlling node 506d includes an indicator which will be referred to as Early_User_Location_Info in the following message sent to the session management node 506c.

After receiving the Early User Location indicator and PCC rule with 5QI=1, the session management node 506c performs the following actions:

Action 601: the session management node 506c first obtains the user location. For example, the session management node 506c may requests user location from the access and mobility management node 506a.

Then the session management node 506c reports the user location to the policy controlling node 506d, and the policy controlling node 506d further reports it to the application node 520a. For example, in action 601a the P-CSCF sends a SIP Inviate message, including NPLI to the IMS core, such as to the first application node 520a.

Call setup continues. The access and mobility management node 506a may retrieve the user location from the AN 503, e.g., from the gNB.

Action 602: After that, the session management node 506c initiates the QoS resource reservation for 5QI=1, that is for dedicated QoS flow associated with voice. Further, during the set up of dedicated resources for the service the IMS Core sends a SIP 18x message, including an SDP Answer and NPLI, to the P-CSCF, such as to the first application node 520a.

Action 603: the session management node 506c may perform QoS resource modification for 5QI=1.

Thus, in order to overcome the problems of the existing solutions, embodiments herein are directed to reporting the early network-provided location information from the session management node 506c to the policy controlling node 506d before initiating resource reservation for the service as shown in FIG. 6. Thus, the early network-provided location information is early since it is reported before the session management node 506c initiates resource reservation for the service.

The above solution is applicable for VoNR, but also for EPS Fallback and Voice over LTE (VoLTE) served by the session management node 506c and the PGW-C.

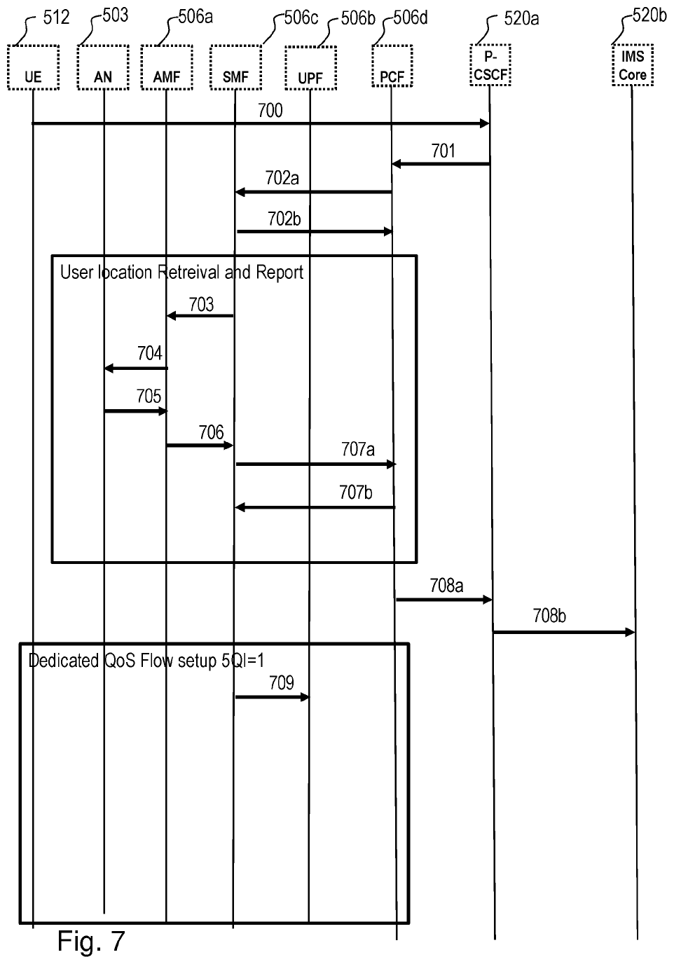

FIG. 7 is a signalling diagram which illustrates further details of the embodiments herein, more specifically of the interaction between the policy controlling node 506d, the session management node 506c, and the application node 520a.

In relation to FIG. 7 the policy controlling node 506d will be exemplified with a PCF, the session management node 506c will be exemplified with an SMF, and the application node 520a will be exemplified with a P-CSCF. Further, the communications device 512 will be exemplified with a UE, and the access and management node will be exemplified with an AMF. Further, the embodiments are described in the context of a 5G network.

### Message 700

The P-CSCF receives a SIP INVITE comprising SDP offer from the UE.

### Message 701

When the P-CSCF receives a SIP INVITE comprising SDP offer (not shown in FIG. 7), the P-CSCF requests the user location from the PCF and sets Preliminary Service Info in Rx Authorization and Authentication Request (AAR). In addition the P-CSCF may also send the indicator Early_User_Location_Info to the PCF.

### Message 702a

After receiving Preliminary Service Info and User Location, or after receiving the Indicator Early User Location, the PCF sets the indicator Early_User_Location_Info. Then the PCF sends a PCC rule comprising 5QI=1 and indicator Early_User_Location_Info in Npcf_SMPolicyControl_UpdateNotify Request to the SMF.

### Message 702b

After receiving the Npcf_SMPolicyControl_UpdateNotify Request, the SMF responds to the PCF with a Npcf_SMPolicyControl_UpdateNotify Response.

### Message 703

When receiving the indicator EARLY_USER_LOCATION_INFO, the SMF buffers the PCC rule (5QI=1), and optionally subscribes the User Location from the AMF in a Namf_EventExposure_Subscribe(EventType=LocationReport) message. The message may comprise a CellId parameter which requests latest location information.

### Message 704

Optionally, the AMF requests the user location from the gNB with a location Reporting Control message.

### Message 705

After receiving Message 704, the gNB reports the user location to the AMF with a Location report message.

### Message 706

After receiving message 705, the AMF sends the user location to the SMF in Namf_EventExposure_Notify. The user location may be indicated by TAI and/or Cell ID.

### Message 707a

The SMF reports an early user location to PCF in Npcf_SMPolicyControl_Update Request(UserLocation Report). That is, the SMF reports a user location before it reserves resources for the voice service (5QI=1).

### Message 707b

The PCF responds to the Npcf_SMPolicyControl_Update(UserLocation Report) with a Npcf_SMPolicyControl_Update Response.

### Messages 708a

The PCF sends a Re-Authorization Request (RAR) message to the P-CSCF comprising a User Location Report.

In order to have a symmetric request and response, the PCF sends user location to P-CSCF if the indicator Early_User_Location_Info is not included in message 701; or the PCF sends the early user location to the P-CSCF if the indicator Early_User_Location_Info is included in message 701.

The P-CSCF may respond with an Re-Authorization Answer (RAA) in response to the RAR. The RAA is a kind of acknowledgment of the RAR reception.

### Message 708b

And then the P-CSCF includes the user location or the early user location in a P-Access-Network-Info (PANI) header and sends SIP INVITE(offer) to the IMS Core. The call setup continues.

### Message 709

Based on the PCC rule received in message 702 comprising 5QI=1, the SMF initiates the dedicated QoS flow creation for Voice, e.g., by sending an N4 Session Modification Request to the UPF. The N4 Session Modification Request may comprise the following parameters: UL PDR, URR(s).

Initiating the dedicated QoS flow creation for Voice may include:
dedicated QoS flow Creation on N4 for uplink, or
dedicated QoS flow creation on N1/N2/N11.

The following further signalling and actions for establishing a dedicated QoS Flow may follow existing solutions.

When a SIP 18x(SDP Answer) message from the IMS Core is received by the P-CSCF, the P-CSCF sends an AAR message with the updated media component to the PCF, and the PCF sends the updated PCC rule to the SMF.

The SMF buffers the PCC rule.

Dedicated QoS flow setup and report of successful resource allocation according to existing methods may then be applied. If EPS Fallback is used this procedure may be modified according to the existing EPS Fallback procedure

When the dedicated QoS flow setup completes, the SMF updates the dedicated QoS flow based on the buffered PCC rule.

The above solution is also applicable for N7 for 4G access. (i.e., Volte based on PGW-C+SMF with Service Based Interfaces (SBI)). Then User Location retrieval in messages 703-706 may then be replaced with related EPS messages. EPS bearer ID (EBI) for default bearer is used to retrieve location as it is mandatory in this procedure.

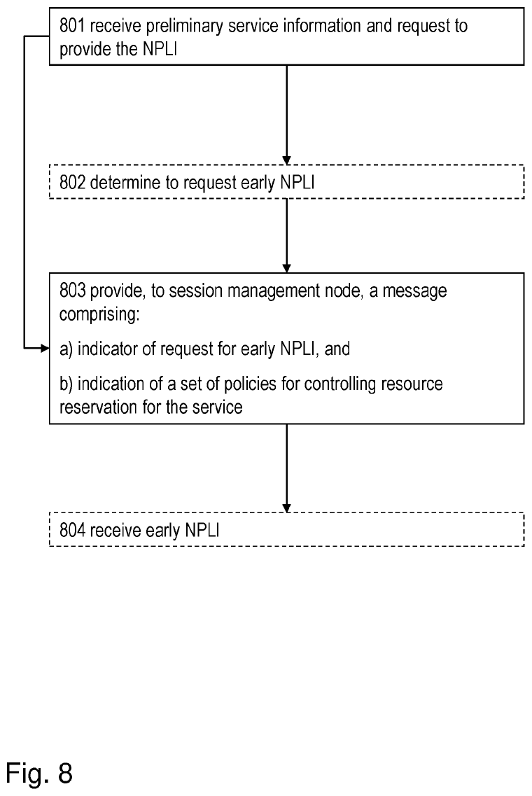

Exemplifying methods according to embodiments herein will now be described with reference to flowcharts of FIGS. 8-10 and with further reference to FIG. 5. The flowcharts of FIGS. 8-10 complement the above-described signalling diagrams and describe exemplifying methods according to embodiments herein from a node perspective. Thus, FIGS. 8-10 describe methods performed by the policy controlling node 506d, the session management node 506c and the application node 520a.

The methods are for handling a service for a communications device 512 in the communications network 500. As mentioned above, the service may be provided to the communications device 512 through the CN of the communications network 500 which may be controlled by the application layer system 520 for providing the service. In particular, the service may be provided by a data session which is set up by the application layer system 520 and the CN of the communications network 500. For example, the data session may be an IMS session.

In some embodiments the application layer system 520 is an Internet Protocol-based multimedia system, such as IMS, providing the service to the communications device 512 and the application node 520a implements a Proxy-Call Session Control function of the Internet Protocol-based multimedia system.

The service may be any one or more out of: voice, video and real-time gaming. Other services may also be applicable.a

The method comprises one or more of the following actions, which actions may be taken in any suitable order.

FIG. 8 illustrates example methods performed by the policy controlling node 506d.

### Action 801

The policy controlling node 506d receives, during the establishment of the service, from the application node 520a of the application layer system 520 providing the service, a first message 701 comprising a preliminary service information for the service and an indicator of a request to provide network-provided location information.

Action 801 may correspond to sending message 701 of FIG. 7.

### Action 802

The above-mentioned first message 701 may trigger the policy controlling node 506d to request an early network-provided location information. For example, the policy controlling node 506d may determine to request the early network-provided location information in response to the first message 701 in order to avoid installation of policies for controlling resource reservation for the service on a default QoS flow, such as 5QI=5, when a SIP precondition is used and avoid voice payload on the default QoS flow when the SIP precondition is not used.

### Action 803

In response to receiving the first message, the policy controlling node 506d provides a second message 702, to the session management node 506c controlling the data session of the communications device 512. As mentioned above, the data session is associated with the service. The second message 702 comprises an indicator of a request for early network-provided location information to be provided before resource reservation for the service is performed and an indication of a set of policies for controlling resource reservation for the service, wherein the indication of the set of policies is based on the preliminary service information received in the first message 701. The set of policies for controlling resource reservation for the service may for example be a PCC rule set.

The set of policies for controlling resource reservation for the service may control Quality of Service, QoS, flow and/or bearers for the service. That is, when a 5G CN is used the set of policies for controlling resource reservation controls QoS flow for the service. When a 4G CN is used the set of policies for controlling resource reservation controls bearers for the service.

The indication of the set of policies for controlling resource reservation for the service may be a 5G Quality of Service indicator, 5QI, or a QoS Class Identifier, QCI, e.g., for 4G.

In some embodiments the indication of the set of policies for controlling resource reservation for the service controls reservation of dedicated resources. For example, the 5QI may be set to 1.

In some embodiments the preliminary service information triggers the policy controlling node 506d to request the early network-provided location information.

In some other embodiments the indicator of the request for the network-provided location information comprises the indicator of the request for the early network-provided location information which triggers the policy controlling node 506d to request the early network-provided location information.

Yet some further embodiments may combine the two above-mentioned embodiments for triggering the policy controlling node 506d to request the early network-provided location information.

The policy controlling node 506d sends the second message 702 and requests the early network-provided location information in response to the first message 701 in order to avoid installation of policies for controlling resource reservation for the service on a default QoS flow, such as 5QI=5, when a SIP precondition is used and to avoid voice payload on the default QoS flow when the SIP precondition is not used. Further, the implementation of the SMF, e.g., implemented by the session management node 506c, is simplified and the performance of the SMF and the UPF is improved since there is no need for interaction on the N4 interface for user location retrieval. The performance of the SMF is further improved since there is no need for the charging data report to the CHF.

Action 803 may correspond to sending message 702 of FIG. 7.

### Action 804

The policy controlling node 506d receives, from the session management node 506c, the early network-provided location information in response to providing the second message 702 to the session management node 506c.

Action 804 may correspond to sending message 707 of FIG. 7.

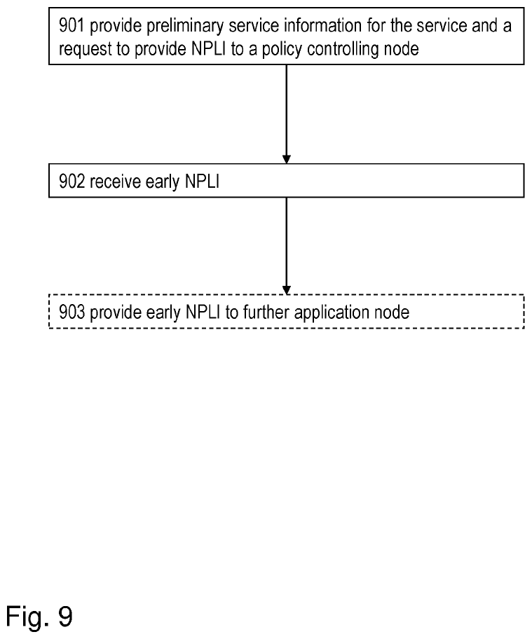

FIG. 9 illustrates example methods, performed by the application node 520a of the application layer system 520, for handling the service for the communications device 512 provided by the application layer system 520.

### Action 901

In action 901 the application node 520a provides to the policy controlling node 506d of the communications network 500, during the establishment of the service, the message comprising preliminary service information for the service and the indicator of the request for network-provided location information.

The request for the network-provided location information may comprise the indicator of the request for the early network-provided location information.

Action 901 may correspond to sending message 701 of FIG. 7.

### Action 902

In response to providing the message to the policy controlling node 506d the application node 520a receives, from the policy controlling node 506d, the early network-provided location information sent to the policy controlling node 506d before resource reservation for the service is performed.

Action 902 may correspond to sending message 708 of FIG. 7.

### Action 903

In some embodiments the application node 520a provides the early network-provided location information to a further application node, such as the second application node 520b, of the application layer system 520. This may be done in order to use the early network-provided location information in a charging interface, to use it in IMS layer services, for example to translate numbers, or select media functions closer to UE location, etc.

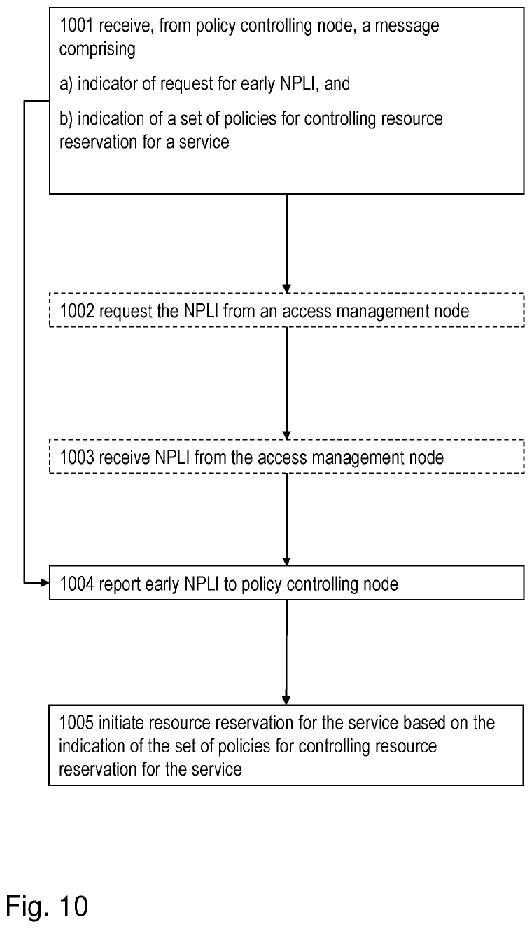

FIG. 10 illustrates example methods, performed by the session management node 506c of the communications network 500, for handling the service for the communications device 512 in the communications network 500. The service is provided by the application layer system 520.

### Action 1001

The session management node 506c receives, from the policy controlling node 506d of the communications network 500 and during the establishment of the service, the message 702 comprising the indicator of the request for early network-provided location information to be provided before resource reservation for the service is performed and the indication of the set of policies for controlling resource reservation for the service.

Action 1001 may correspond to sending message 702 of FIG. 7.

### Action 1002

In response to receiving the indicator of the request for the early network-provided location information in action 1001, the session management node 506c may request a network-provided location information from the access and mobility management node 506a. The network-provided location information may also be referred to as a user location information.

In some embodiments, e.g., for a 4G CN, requesting the network-provided location information from the access and mobility management node 506a is based on a default bearer. For example, with a 4G CN the SMF and PGW-C may retrieve user location from the SGW and/or the MME based on a default bearer.

Action 1002 may correspond to sending message 703 of FIG. 7.

### Action 1003

If the session management node 506c has requested the network-provided location information from the access and mobility management node 506a in action 1002 above, then it receives the network-provided location information from the access and mobility management node 506a in action 1003.

Action 1003 may correspond to sending message 706 of FIG. 7.

### Action 1004

In response to receiving the indicator of the request for the early network-provided location information, the session management node 506c reports the early network-provided location information to the policy controlling node 506d before initiating resource reservation for the service.

Further, in response to receiving the network-provided location information from the access and mobility management node 506a in action 1003 above, the session management node 506c reports the received network-provided location information as the early network-provided location information to the policy controlling node 506d before initiating resource reservation for the service.

Action 1004 may correspond to sending message 707 of FIG. 7.

### Action 1005

In action 1005 the session management node 506c initiates resource reservation for the service based on the received indication of the set of policies for controlling resource reservation for the service. For example, the session management node 506c may initiate resource reservation on dedicated resources, such as on a dedicated QoS Flow. For example, if a 5QI is set to 1, then the session management node 506c may initiate resource reservation on dedicated resources for IMS voice.

Action 1005 may correspond to dedicated QoS setup 5Q=1 of FIG. 7.

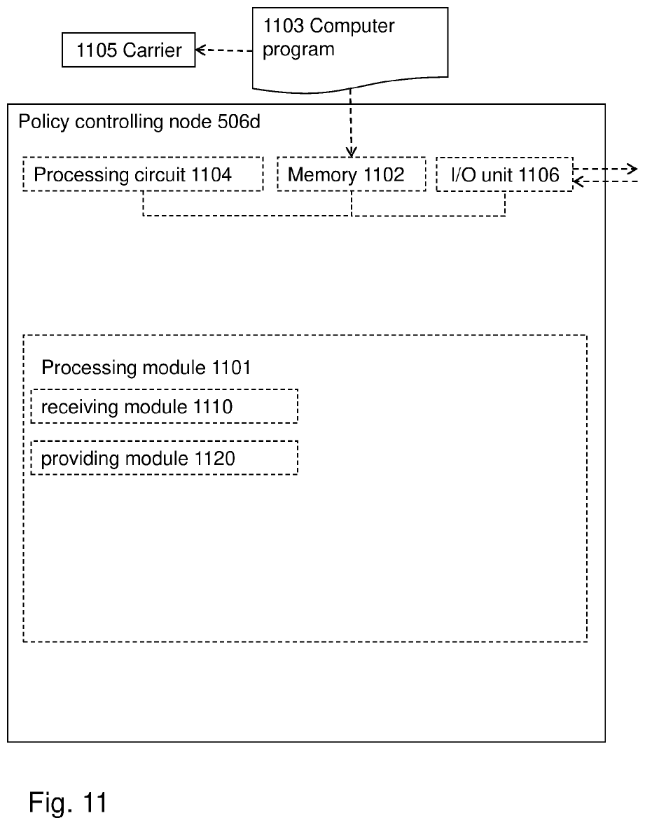

FIG. 11 illustrates a schematic block diagram of embodiments of the policy controlling node 506d.

The policy controlling node 506d may comprise a processing module 1101 for performing the above method actions. The processing module 1101 may comprise a receiving module 1110 to, e.g. receive the first message.

Thus the policy controlling node 506d is configured to, e.g. by means of the receiving module 1110, receive, during the establishment of the service and from the application node 520a of the application layer system 520 providing the service, the first message comprising the preliminary service information for the service and the indicator of the request to provide network-provided location information.

The processing module 1101 may comprise a providing module 1120 to, e.g. provide the second message. Thus the policy controlling node 506d is configured to, e.g. by means of the providing module 1120, provide the second message to the session management node 506c of the communications network 500 controlling a data session of the communications device. The data session is associated with the service. The second message 702 comprises the indicator of the request for early network-provided location information to be provided before resource reservation for the service is performed and the indication of the set of policies for controlling resource reservation for the service. The indication of the set of policies is based on the preliminary service information received in the first message 701.

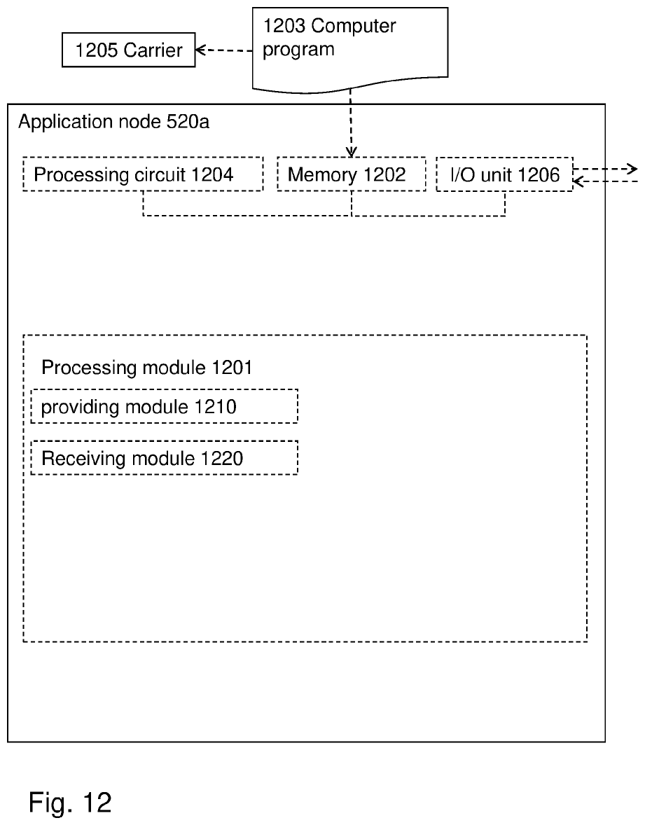

FIG. 12 illustrates a schematic block diagram of embodiments of the application node 520a.

The application node 520a may comprise a processing module 1201 for performing the above method actions. The processing module 1201 may comprise a providing module 1210 to, e.g. provide the first message.

Thus, the application node 520a is configured to, e.g. by means of the providing module 1210, provide to the policy controlling node 506d of the communications network 500 and during the establishment of the service, the message comprising preliminary service information for the service and the indicator of the request for network-provided location information.

The processing module 1201 may comprise a receiving module 1220.

The application node 520a is configured to, e.g. by means of the providing module 1210, receive from the policy controlling node 506d, the early network-provided location information sent to the policy controlling node 506d before resource reservation for the service is performed in response to providing the message to the policy controlling node 506d.

In some embodiments, the application node 520a is further configured to, e.g. by means of the providing module 1210, provide the early network-provided location information to the further application node 520b of the application layer system 520.

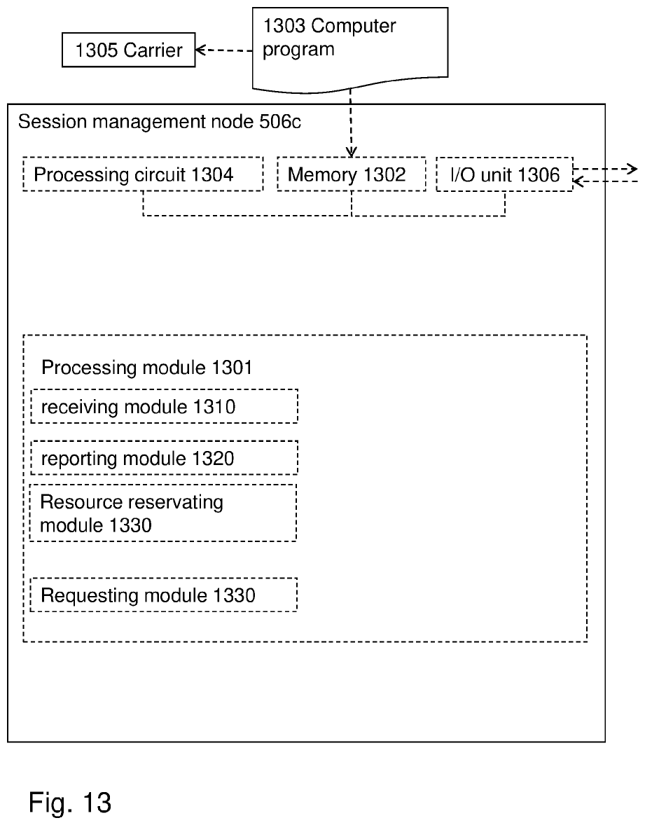

FIG. 13 illustrates a schematic block diagram of embodiments of the session management node 506c.

The session management node 506c may comprise a processing module 1301 for performing the above method actions. The processing module 1301 may comprise a receiving module 1310 to, e.g. receive the second message.

Thus, the session management node 506c is configured to, e.g. by means of the receiving module 1310, receive, from a policy controlling node 506d of the communications network 500 and during the establishment of the service, a message 702 comprising the indicator of the request for early network-provided location information to be provided before resource reservation for the service is performed and the indication of the set of policies for controlling resource reservation for the service.

The processing module 1301 may further comprise a reporting module 1320. Thus, the session management node 506c is configured to, e.g. by means of the reporting module 1320, report the early network-provided location information to the policy controlling node 506d before initiating resource reservation for the service, in response to receiving the indicator of the request for the early network-provided location information.

The processing module 1301 may further comprise a resource reservating module 1330. Thus, the session management node 506c is configured to, e.g. by means of the resource reservating module 1330, initiate resource reservation for the service based on the received indication of the set of policies for controlling resource reservation for the service.

In some embodiments, the session management node 506c is further configured to, e.g. by means of a requesting module 1330, in response to receiving the indicator of the request for the early network-provided location information, request the network-provided location information from the access and mobility management node 506a.

Then, the session management node 506c is further configured to, e.g. by means of the receiving module 1310, receive the network-provided location information from the access and mobility management node 506a, and e.g. by means of the reporting module 1320 report the received network-provided location information as the early network-provided location information to the policy controlling node 506d before initiating resource reservation for the service, in response to receiving the network-provided location information.

The policy controlling node 506d, session management node 506c and the application node 520a may comprise a respective input and output unit, 1106, 1206, 1306 configured to communicate with each other, see FIGS. 11-13. The input and output unit may comprise a receiver (not shown) and a transmitter (not shown).

The embodiments herein may be implemented through a respective processor or one or more processors, such as the respective processing circuit 1104, 1204 and 1304 in the policy controlling node 506d, the session management node 506c and application node 520a depicted in FIGS. 11-13, together with computer program code for performing the functions and actions of the embodiments herein. The program code mentioned above may also be provided as a computer program product, for instance in the form of a data carrier carrying computer program code for performing the embodiments herein when being loaded into the respective policy controlling node 506d, session management node 506c and application node 520a. One such carrier may be in the form of a CD ROM disc. It is however feasible with other data carriers such as a memory stick. The computer program code may furthermore be provided as pure program code on a server or a cloud and downloaded to the respective policy controlling node 506d, session management node 506c and application node 520a.

The policy controlling node 506d, the session management node 506c and the application node 520a may further comprise a respective memory 1102, 1202, and 1302 comprising one or more memory units. The memory comprises instructions executable by the processor in the policy controlling node 506d, session management node 506c and the application node 520a.

Each respective memory 1102, 1202 and 1302 is arranged to be used to store e.g. information, data, configurations, and applications to perform the methods herein when being executed in the respective policy controlling node 506d, session management node 506c and application node 520a.

In some embodiments, a respective computer program 1103, 1203 and 1303 comprises instructions, which when executed by the at least one processor, cause the at least one processor of the respective policy controlling node 506d, session management node 506c and application node 520a to perform the actions above.

In some embodiments, a respective carrier 1105, 1205 and 1305 comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units in the units described above may refer to a combination of analog and digital circuits, and/or one or more processors configured with software and/or firmware, e.g. stored in the respective policy controlling node 506d, session management node 506c and application node 520a, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

It should be noted that there are no FIGS. 14-15.

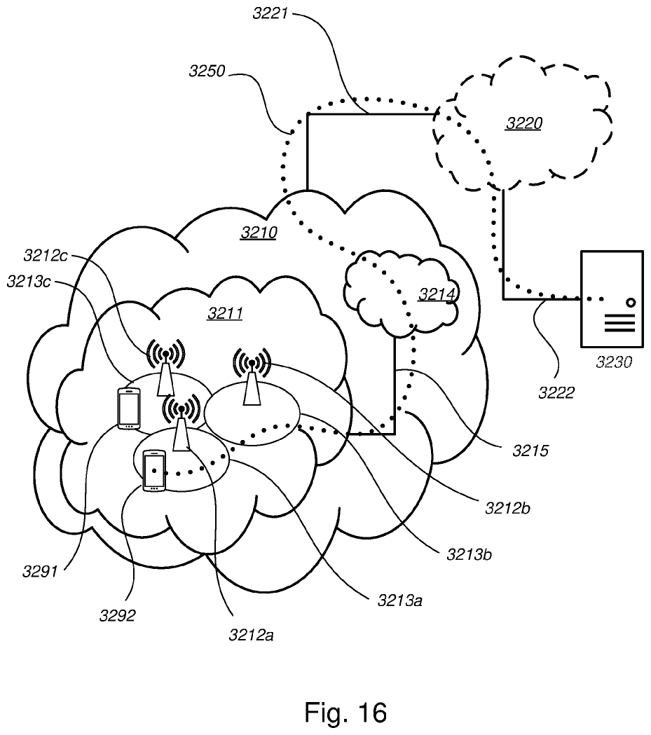

With reference to FIG. 16, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the source and target access node 111, 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

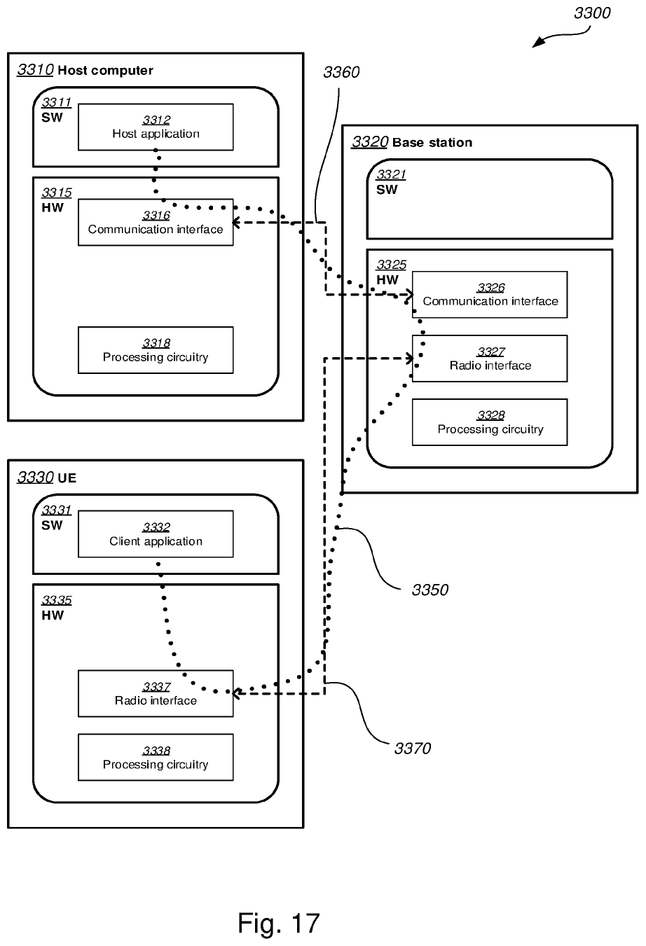

The communication system of FIG. 16 as a whole enables connectivity between one of the connected UEs 3291, 3292 such as e.g. the UE 121, and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230. Example implementations, in accordance with an embodiment, of the UE, base station and host computer discussed in the preceding paragraphs will now be described with reference to FIG. 17. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 17) served by the base station 3320. The communication interface 3326 may be configured to facilitate a connection 3360 to the host computer 3310. The connection 3360 may be direct or it may pass through a core network (not shown in FIG. 17) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.
The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.
It is noted that the host computer 3310, base station 3320 and UE 3330 illustrated in FIG. 17 may be identical to the host computer 3230, one of the base stations 3212a, 3212b, 3212c and one of the UEs 3291, 3292 of FIG. 16, respectively. This is to say, the inner workings of these entities may be as shown in FIG. 17 and independently, the surrounding network topology may be that of FIG. 16.

In FIG. 17, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

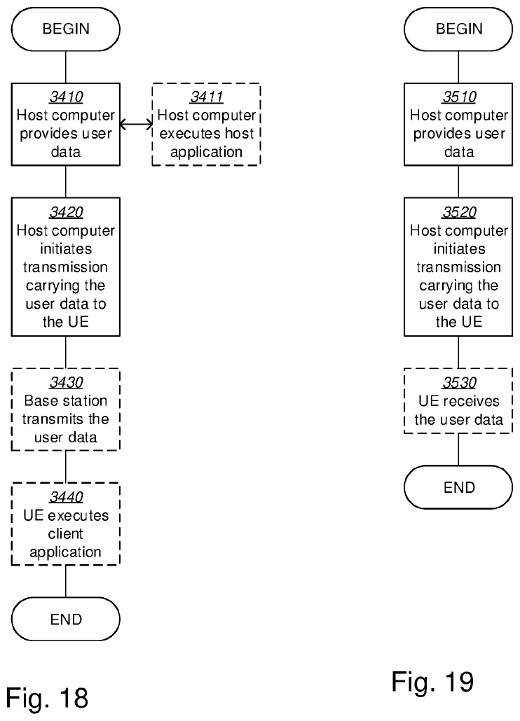

FIG. 18 is a flowchart illustrating a method implemented in a communication system, in accordance with one embodiment. The communication system includes a host computer, a base station such as a AP STA, and a UE such as a Non-AP STA which may be those described with reference to FIG. 16 and FIG. 17. For simplicity of the present disclosure, only drawing references to FIG. 18 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 19 is a flowchart illustrating a method implemented in a communication system, in accordance with one embodiment. The communication system includes a host computer, a base station such as a AP STA, and a UE such as a Non-AP STA which may be those described with reference to FIG. 16 and FIG. 17. For simplicity of the present disclosure, only drawing references to FIG. 19 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

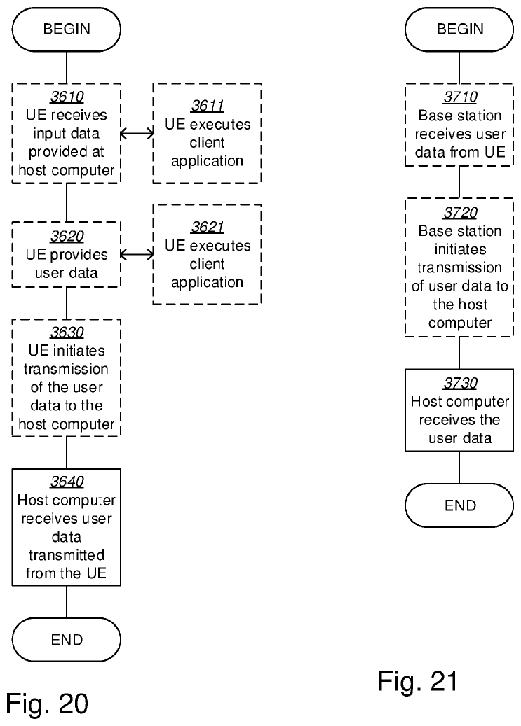

FIG. 20 is a flowchart illustrating a method implemented in a communication system, in accordance with one embodiment. The communication system includes a host computer, a base station such as a AP STA, and a UE such as a Non-AP STA which may be those described with reference to FIG. 16 and FIG. 17. For simplicity of the present disclosure, only drawing references to FIG. 20 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 21 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method, performed by a policy controlling node of a communications network, for handling a service for a communications device in the communications network, the method comprising:
receiving, during the establishment of the service, from an application node of an application layer system providing the service, a first message comprising a preliminary service information for the service and an indicator of a request to provide network-provided location information; and
in response to receiving the first message, providing a second message, to a session management node of the communications network controlling a data session of the communications device, which data session is associated with the service, wherein the second message comprises an indicator of a request for early network-provided location information to be provided before resource reservation for the service is performed and an indication of a set of policies for controlling resource reservation for the service, wherein the indication of the set of policies is based on the preliminary service information received in the first message.

2. The method according to claim 1, wherein the preliminary service information triggers the policy controlling node to request the early network-provided location information and/or wherein the indicator of the request for the network-provided location information comprises the indicator of the request for the early network-provided location information which triggers the policy controlling node to request the early network-provided location information.

3. The method according to claim 1, wherein the set of policies for controlling resource reservation for the service controls Quality of Service, QoS, flow and/or bearers for the service.

4. The method according to claim 1, wherein the indication of the set of policies for controlling resource reservation for the service is a 5G Quality of Service indicator, 5QI, or a QoS Class Identifier, QCI.

5. The method according to claim 1, wherein the service is any one or more out of: voice, video and real-time gaming.

6. The method according to claim 1, further comprising, in response to providing the second message to the session management node, receiving, from the session management node, the early network-provided location information.

7. The method according to claim 1, wherein the indication of the set of policies for controlling resource reservation for the service controls reservation of dedicated resources.

8. The method according to claim 1, wherein the application layer system is an Internet Protocol-based multimedia system providing the service to the communications device and the application node implements a Proxy-Call Session Control function of the Internet Protocol-based multimedia system.

9. A policy controlling node of a communications network, for handling a service for a communications device in the communications network, wherein the policy controlling node is configured to:
receive, during the establishment of the service, from an application node of an application layer system providing the service, a first message comprising a preliminary service information for the service and an indicator of a request to provide network-provided location information; and
in response to receiving the first message, provide a second message, to a session management node of the communications network controlling a data session of the communications device, which data session is associated with the service, wherein the second message comprises an indicator of a request for early network-provided location information to be provided before resource reservation for the service is performed and an indication of a set of policies for controlling resource reservation for the service, wherein the indication of the set of policies is based on the preliminary service information received in the first message.

10. The policy controlling node according to claim 9, wherein the preliminary service information triggers the policy controlling node to request the early network-provided location information and/or wherein the indicator of the request for the network-provided location information comprises the indicator of the request for the early network-provided location information which triggers the policy controlling node to request the early network-provided location information.

11. The policy controlling node according to claim 9, wherein the set of policies for controlling resource reservation for the service controls Quality of Service, QoS, flow and/or bearers for the service.

12. The policy controlling node according to claim 9, wherein the indication of the set of policies for controlling resource reservation for the service is a 5G Quality of Service indicator, 5QI, or a QoS Class Identifier, QCI.

13. The policy controlling node according to claim 9, wherein the service is any one or more out of: voice, video and real-time gaming.

14. The policy controlling node according to claim 9, further configured to, in response to providing the second message to the session management node, receive, from the session management node, the early network-provided location information.

15. The policy controlling node according to claim 9, wherein the indication of the set of policies for controlling resource reservation for the service controls reservation of dedicated resources.

16. The policy controlling node according to claim 9, wherein the application layer system is an Internet Protocol-based multimedia system providing the service to the communications device and the application node implements a Proxy-Call Session Control function of the Internet Protocol-based multimedia system.

17. A method, performed by a session management node of a communications network, for handling a service for a communications device in the communications network, wherein the service is provided by an application layer system, the method comprising:
receiving, from a policy controlling node of the communications network and during the establishment of the service, a message comprising an indicator of a request for early network-provided location information to be provided before resource reservation for the service is performed and an indication of a set of policies for controlling resource reservation for the service; and
in response to receiving the indicator of the request for the early network-provided location information, reporting the early network-provided location information to the policy controlling node before initiating resource reservation for the service; and
initiating resource reservation for the service based on the received indication of the set of policies for controlling resource reservation for the service.

18. The method according to claim 17, wherein the indication of the set of policies for controlling resource reservation for the service controls reservation of dedicated resources.

19. The method according to claim 17, further comprising:
in response to receiving the indicator of the request for the early network-provided location information, requesting a network-provided location information from an access and mobility management node;
receiving the network-provided location information from the access and mobility management node; and
in response to receiving the network-provided location information, reporting the received network-provided location information as the early network-provided location information to the policy controlling node before initiating resource reservation for the service.

20. The method according to claim 19, wherein requesting the network-provided location information from the access and mobility management node is based on a default bearer.

21-32. (canceled)
